(19) United States
(12) Patent Application Publication
(10) Pub. No.: US 2019/0257341 A1
(43) Pub. Date: Aug. 22, 2019

(54) ANNULAR PLUG-IN COUPLING AND METHOD FOR PRODUCING A CONNECTION BETWEEN COMPONENTS WITH THE AID OF THE ANNULAR PLUG-IN COUPLING

(71) Applicant: BÖLLHOFF VERBINDUNGSTECHNIK GmbH, Bielefeld (DE)

(72) Inventors: Andreas Arndt, Kalletal (DE); Michael König, Bielefeld (DE)

(21) Appl. No.: 16/345,297

(22) PCT Filed: Jul. 31, 2017
(86) PCT No.: PCT/EP2017/069326

§ 371 Date: Apr. 26, 2019

(30) Foreign Application Priority Data
Oct. 28, 2016 (DE) 10 2016 120 650.4

(51) Int. Cl. F16B 21/07

(52) U.S. Cl. CPC F16B 21/075; B60Q 1/30

(57) ABSTRACT

An annular plug-in coupling having a ring structure with a longitudinal axis, a radial inner side and a radial outer side, a fastening structure on the outer side of the ring structure with a first and a second undercut acting against one another in the longitudinal direction of the ring structure, of which at least the first undercut can be moved resiliently in the radial direction, a latching structure arranged centrally the ring structure, with which a coupling pin of a second component can be releasably connected and which consists of at least three spring arms, the width of which is arranged in the longitudinal direction of the ring structure and is greater than a thickness, the spring arms extend inwards from the radial inner side of the ring structure and end in a free fastening end which include at least an insertion slope and a clamping portion.

### 1. TECHNICAL FIELD

The present disclosure relates to an annular plug-in coupling which can be fastened in a component opening of a first component. Furthermore, this disclosure relates to a connection between two components by means of this annular plug-in coupling, in particular a connection between a component fixed to the vehicle, such as the bodywork or the vehicle frame, and an attachment component, such as a headlight. The present disclosure further comprises a connection method for establishing a connection between a first and a second component by means of the annular plug-in coupling.

### 2. BACKGROUND

Plug-in couplings are used, for example, in automotive manufacturing to fasten attachment components such as lights, trims and the like to fixed or integral parts of the vehicle. These fixed components of the motor vehicle include the vehicle bodywork, the vehicle frame and other rigidly arranged parts in the vehicle.

It is an important objective of the connection to be established here to require little time and effort for its establishment. For this reason, plug-in couplings consisting of a flexible ball socket and a ball head attached to opposing components are frequently used. Once the ball head snaps into the ball socket, the connection between the two components is established.

It has become apparent that when connecting two components, it is frequently necessary to compensate for tolerances. These tolerances result from geometric designs of the parts to be connected, from a tolerance-affected arrangement of component openings in which the plug-in coupling of the future connection is to be arranged, or from improperly aligned plug-in couplings and coupling pins to be connected with the same. If these tolerances are not compensated, they can generate mechanical stresses in the established connection consisting of coupling pin and plug-in coupling, which are disadvantageously supportive of releasing the connection.

In order to be able to establish a tolerance-compensating connection, DE 43 34 926 A1, U.S. Pat. No. 7,927,050 B2 and EP 2 757 272 A1, for example, disclose a coupling pin flexibly arranged in a ring structure. While this ring structure provides a fastening option for this coupling in a component opening, the pin arranged flexibly within the ring structure is used to produce a snap-in connection with a coupling adapted to it. In order to provide the flexibility of the pin in a radial direction, the pin is fastened within the ring structure with spring arms. This makes it possible for the pin to move radially within the ring structure or within the plane of the ring structure and thus compensate for tolerances.

If two components are connected exclusively with these flexible coupling constructions, this leads to a movable connection instead of a rigid one. Such a connection does not ensure an aesthetically desired gap dimension, for example of a headlight in a bodywork opening. In addition, such a connection is susceptible to vibrations that affect both the connection and the interconnected parts.

DE 20 2013 011 533 U1 discloses another plug-in coupling of the prior art. The ring-shaped plug-in coupling described here has differently configured spring arms for holding a centrally arranged ball socket and for latching into an adapted component opening. Since these web-shaped spring arms are oriented differently with respect to the longitudinal axis of the plug-in coupling described here, they provide a firmer connection to a coupling pin. Although this plug-in coupling ensures a radial tolerance compensation, its configuration is less flexible than the plug-in couplings described above. The reason for this is that two differently oriented spring arm configurations are used here, while the prior art described above is limited to only one type of centrally arranged spring arms.

With regard to the known plug-in couplings, the established connection thus still remains a compromise between tolerance compensation and the desired connection stability and strength. In order to improve this compromise, an annular plug-in coupling is described in the following, which establishes a connection between two components by means of a coupling pin. With this plug-in coupling, it is possible to establish both a tolerance-reduced, fixed or firm connection between two components as well as a tolerance-compensating connection.

### 3. SUMMARY

The above object is solved by an annular plug-in coupling, a connection between a first component and a second component by means of the above-mentioned plug-in coupling as well as by a connection method for a first and a second component by means of the above-mentioned plug-in coupling and a corresponding coupling pin. Further embodiments and further developments are set forth in the following description, the accompanying drawings and the claims.

The annular plug-in coupling is fastened in a component opening of a first component. This annular plug-in coupling has the following features: a hollow cylindrical ring structure with a longitudinal axis and a radial inner side and a radial outer side, a fastening structure arranged on the radial outer side with which the ring structure can be fastened in the component opening, a latching structure arranged centrally in the interior of the ring structure, with which latching structure a coupling pin of a second component can be releasably connected to the plug-in coupling and which consists of at least three band-like spring arms which extend curvilinearly radially inwards from the radial inner side of the ring structure and each of which ends in a free fastening end, the spring arm width of which is arranged in the longitudinal direction of the ring structure and is greater than a spring arm thickness, wherein the fastening ends comprise at least an insertion slope or bevel and a clamping portion.

According to a further embodiment, the ring structure comprises a first and a second undercut acting against each other in the longitudinal direction of the ring structure, of which at least the first undercut is resiliently movable in the radial direction in order to latch the ring structure in the component opening. As an alternative to this fastening construction, the outer side of the ring structure comprises an external thread matching an internal thread in the component opening. According to another embodiment, the outer side of the ring structure is formed as an adhesive surface to be glued into the component opening.

The ring structure of the plug-in coupling is adapted to an opening in a component in a known manner. Here, the plug-in coupling is plugged in without great effort and is latched or screwed in or glued in place. In the case of a latching connection, the ring structure is retained on the component between the undercuts provided on the radial outer side of the ring structure. This can also be used in combination with the adhesive connection. Radially inward projecting and curvilinear shaped spring arms are located at the center of the annular plug-in coupling. In contrast to known plug-in couplings, the ends of these spring arms are in fact not connected to each other. Instead, the ends of the spring arms form engagement points at the coupling pin to be accommodated in the plug-in coupling. Due to the missing connection of the ends of the spring arms, they allow a movement for a tolerance compensation in the radial direction. Accordingly, the spring arms with their fastening ends can move within certain limits, so that the coupling pin can take up its desired position while compensating for existing tolerances within the annular plug-in coupling. Here, a clamping portion is connected to the inserted coupling pin in order to form at least a non-positive or force-fitted connection between the annular plug-in coupling and the coupling pin. Since the coupling pin generally consists of a shaft and a bulged head, this non-positive connection is further complemented by a positive or locking connection between the fastening ends and the coupling pin. Depending on the connection loads to be absorbed by the fastening ends of the spring arms, the number of spring arms within the ring structure is variable. However, at least three spring arms should be provided to support a central arrangement of the coupling pin by the circumferential engagement of the fastening ends. It should also be emphasized that the spring arms arranged inside the ring structure are formed in a band-like manner. Band-like indicates that the spring arms have a width greater than the thickness of the spring arm. This band-width may extend in the axial direction of the annular plug-in coupling and thus ensures axial stability of the connection between plug-in coupling and coupling pin. It is this arrangement of the larger spring arm width in comparison to the spring arm thickness in the longitudinal direction of the plug-in coupling that reduces the deflection of the spring arms in the axial direction of the plug-in coupling. Nevertheless, an axial tolerance compensation between the annular plug-in coupling and the coupling pin is achieved by the fact that the coupling pin can change its axial position over a length of its shaft area between the clamping fastening ends of the spring arms.

According to a further embodiment of the annular plug-in coupling, the spring arm width is arranged in an inclined or parallel manner with respect to the longitudinal direction of the plug-in coupling or is arranged in an inclined and/or parallel manner at least in some regions or sections.

According to another embodiment, the cylindrical ring structure comprises an axial entry side and an axial exit side for the coupling pin to be fastened. In addition, the spring arms are fastened to the radial inner side of the ring structure spaced from the entry side of the ring structure in the longitudinal direction of the ring structure, so that a cylindrical retainer or seat is provided for a radial fixation of the coupling pin in the ring structure.

Due to the above-described configuration of the annular plug-in coupling, the latter serves for providing a fixed bearing in the same way as for producing a floating bearing. In this context, floating bearing means that the connection established between the annular plug-in coupling and the coupling pin contains a radial tolerance compensation function. If, for example, the annular plug-in coupling and the coupling pin are not optimally aligned centrically to each other, a connection between the coupling pin and the annular plug-in coupling is still possible. In this connection, the coupling pin then takes up a non-central arrangement within the ring structure. Within this arrangement, the coupling pin is still held reliably by the fastening ends of the spring arms engaging its shaft. A fixed bearing means that the connection between the annular plug-in coupling and the coupling pin does not allow any or only a greatly reduced compensation of radial tolerances. Such a tolerance compensation may be excluded in order to establish the connection at a fixedly or stationarily defined location or position. For this purpose, the annular plug-in coupling comprises a cylindrical recess on the entry side. This recess is adapted to a cylindrical thickening on the coupling pin which is complementary to it. Consequently, other complementary shapes of annular plug-in couplings and coupling pins can also be selected, such as a conical shape, a hemisphere or the like, which engage in the respective complementary shape. After the cylindrical thickening of the coupling pin has been received in the cylindrical receiving portion of the annular plug-in coupling, the exact fit of these two shapes prevents the compensation of radial tolerances. This is because the cylindrical thickening of the coupling pin may be held without a gap within the cylindrical seat of the annular plug-in coupling. Accordingly, the two interconnected components are fixed radially, since no radial tolerances can be compensated. Thus the connection of coupling pin and plug-in coupling provides a radial fixation.

In accordance with a further embodiment, the insertion slopes of the fastening ends enclose an angle of <45° with the longitudinal axis of the plug-in coupling. The extraction slopes of the fastening ends enclose a larger angle with the longitudinal axis of the plug-in coupling than that between the longitudinal axis and the insertion slope. This freely adjustable angular alignment of the insertion slope and the extraction slope affects the installation and deinstallation effort for the connection to be established. In addition, the angular adjustment of the insertion slope and the extraction slope is selected in close coordination with the spring behaviour of the spring arms. In this context, it may be preferred to form the annular plug-in coupling as an integral plastic part, the plastic of which has a strength in the range of 20-100 MPa. In the same way, it may be preferred to reinforce the spring arms of the annular plug-in coupling with metal inserts or to support their flexibility. Of course, the same applies to the central ring structure of the plug-in coupling.

It further may be preferred that the fastening ends of the spring arms have a retaining face in the clamping portion which is arranged parallel to the longitudinal axis of the plug-in coupling.

The present disclosure further comprises a connection between a first component and a second component, in which the first component comprises a component opening, in which a plug-in coupling according to one of the configurations described above is fastened, and in which a coupling pin is fastened at the second component and which is held in the plug-in coupling of the first component.

As already discussed above, the coupling pin may comprise an elongated shaft and a bulbous head. In addition, according to a design, the coupling pin is provided with a cylindrical thickening in a shaft area facing away from the head, which is adapted to the cylindrical seat of the annular plug-in coupling and can be received therein. In this context it also may be preferred to form the cylindrical thickening integrally with the coupling pin. According to another embodiment, the cylindrical thickening is realized as a sleeve which can be fastened to the coupling pin. If the integrally designed coupling pin with cylindrical thickening is used, then only a fixed bearing in combination with the annular plug-in coupling can be produced with this coupling pin. If a coupling pin is used which has no integral cylindrical thickening, this coupling pin is initially suitable for producing a floating bearing in combination with the annular plug-in coupling. If this coupling pin is equipped with a cylindrical sleeve on its shaft according to the application circumstances, then exactly this coupling pin can also be used to produce a fixed bearing in combination with the annular plug-in coupling. This means that the construction of the coupling pin here can be used variably as an integral component or as a component with a cylindrical sleeve in order to realize both a fixed bearing as well as a floating bearing in a connection to be established.

The present disclosure also includes a connection between a first and a second component, in particular a vehicle body and an attachment component of a vehicle, in which the first component comprises at least two plug-in couplings according to one of the embodiments described above, which are each arranged in a component opening, and the second component comprises two coupling pins matchingly arranged thereto. In this connection, one of the coupling pins comprises a cylindrical thickening in the shaft portion facing away from the head which is received in a cylindrical seat of the plug-in coupling to form a radially fixed connection between the first and the second component. It also may be preferred that the second coupling pin does not include any cylindrical thickening, so that this, with the associated annular plug-in coupling, ensures a radial tolerance compensation between the second annular plug-in coupling and the second coupling pin.

The present disclosure further comprises a connection method for a first and a second component comprising the following steps: arranging at least a first and a second plug-in coupling according to one of the above-described embodiments in a respective component opening of the first component, fastening a first and a second coupling pin in the second component in an arrangement adapted to the arrangement of the first and second plug-in coupling in the first component, wherein one of the coupling pins comprises a cylindrical thickening as a radial fixation in combination with the plug-in coupling, and the other coupling pin is provided without a cylindrical thickening, and plugging and locking the coupling pins in the first and second plug-in couplings of the first component.

In another embodiment of the connection method described above, a coupling pin with a cylindrical thickening is provided as an integral coupling pin or as a coupling pin with a sleeve. In addition, it may be preferred to plug the coupling pin with cylindrical thickening into the ring structure in such a manner that the cylindrical thickening is arranged in the cylindrical seat adjacent to the entry side of the ring structure so that the cylindrical seat prevents a radial displacement of the received cylindrical thickening. This arrangement ensures that a fixed bearing is present between the annular plug-in coupling and the coupling pin with cylindrical thickening. Accordingly, the first and second components can no longer perform any radial compensating movements relative to each other as soon as the coupling pin is fixed in said annular plug-in coupling. Nevertheless, at least one of the components can be rotated around the established fixed bearing in order to set a suitable orientation between the further annular plug-in coupling and the coupling pin adapted thereto. As soon as this desired orientation has been achieved, the coupling pin without a cylindrical thickening is inserted into the annular plug-in coupling and latched to it. By means of this procedure, it is possible to reliably fix an attachment component to a fixed structure and at the same time implement a desired gap dimension with a certain tolerance compensation, e.g. for attachment components in motor vehicles.

### 4. BRIEF DESCRIPTION OF THE ACCOMPANYING DRAWINGS

Some embodiments of the present disclosure are described in more detail with reference to the accompanying drawings. It shows:

FIG. 1 is a perspective view of an embodiment of the annular plug-in coupling with an entry side for a coupling pin in the foreground,

FIG. 2 is a perspective view of an embodiment of the annular plug-in coupling with an exit side for a coupling pin in the foreground,

FIG. 3 is an embodiment of the inserting of the coupling pin on the entry side into the annular plug-in coupling,

FIG. 4 is an embodiment of the coupling pin inserted into the annular plug-in coupling of FIG. 3 having the head of the coupling pin locked,

FIG. 5 is an embodiment of an arrangement of the ball pin on the entry side after being locked in the annular plug-in coupling,

FIG. 6 is a sectional view of the connection according to FIG. 5,

FIG. 7 is another embodiment of an arrangement of a coupling pin with cylindrical thickening when inserting the coupling pin on the entry side into the annular plug-in coupling,

FIG. 8 is the arrangement of FIG. 7 after locking the coupling pin in the plug-in coupling,

FIG. 9 is a sectional view of the connection according to FIG. 8, in which the coupling pin comprises an integral cylindrical thickening,

FIG. 10 is a sectional view of the connection according to FIG. 8, in which the coupling pin comprises a sleeve as cylindrical thickening,

FIG. 11 is an embodiment of a connection of two components with a plurality of plug-in couplings and coupling pins, and

FIG. 12 is a flow chart of an embodiment of the connection method.

### 5. DETAILED DESCRIPTION E

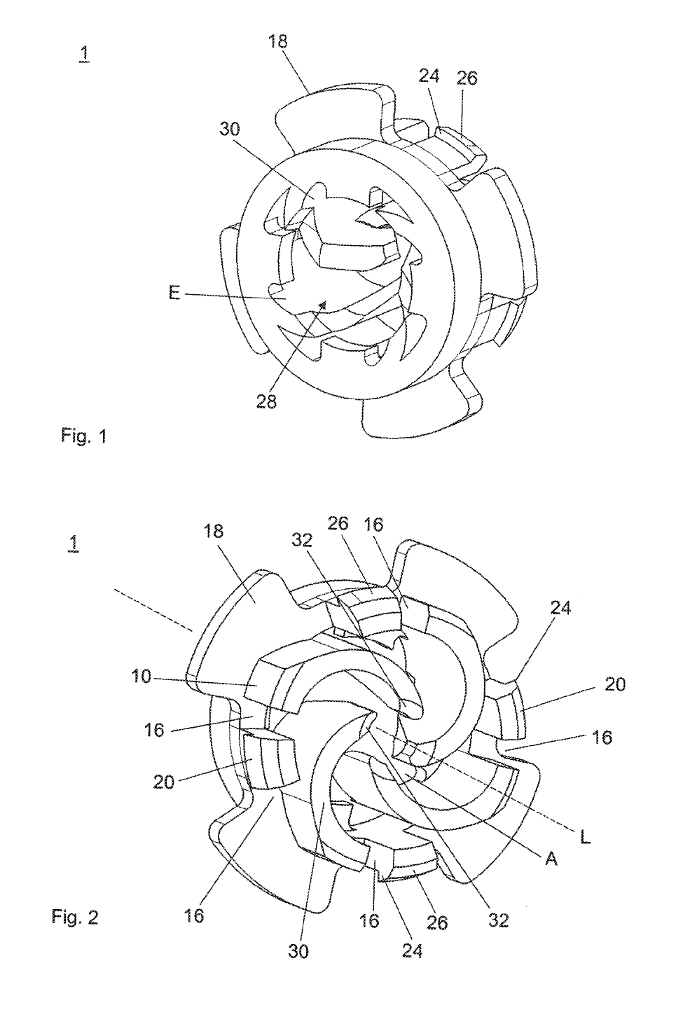

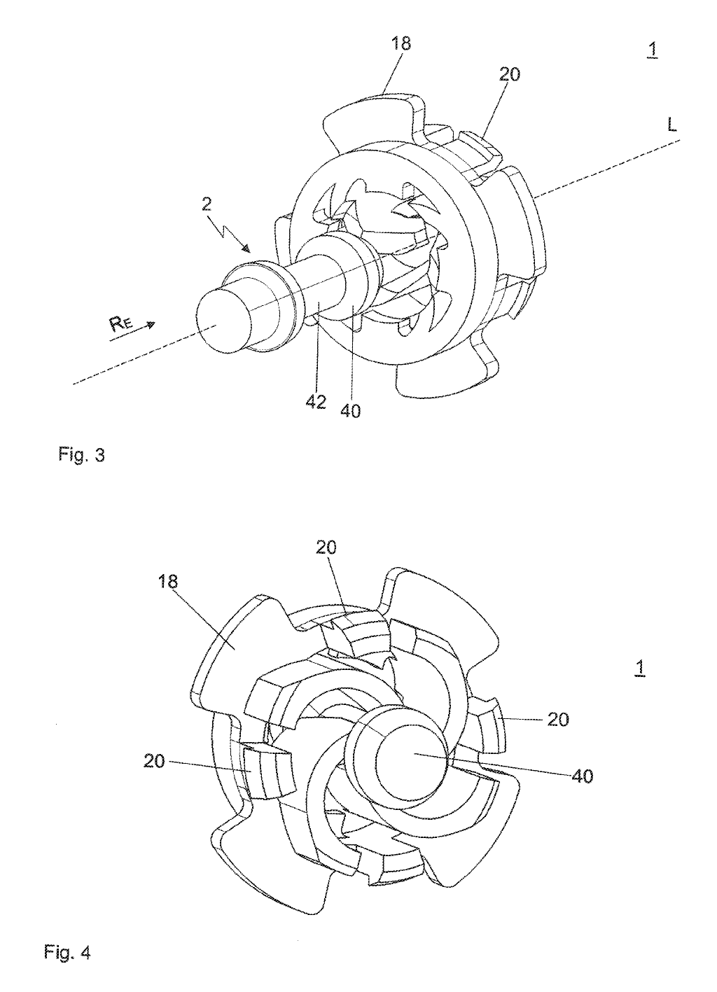

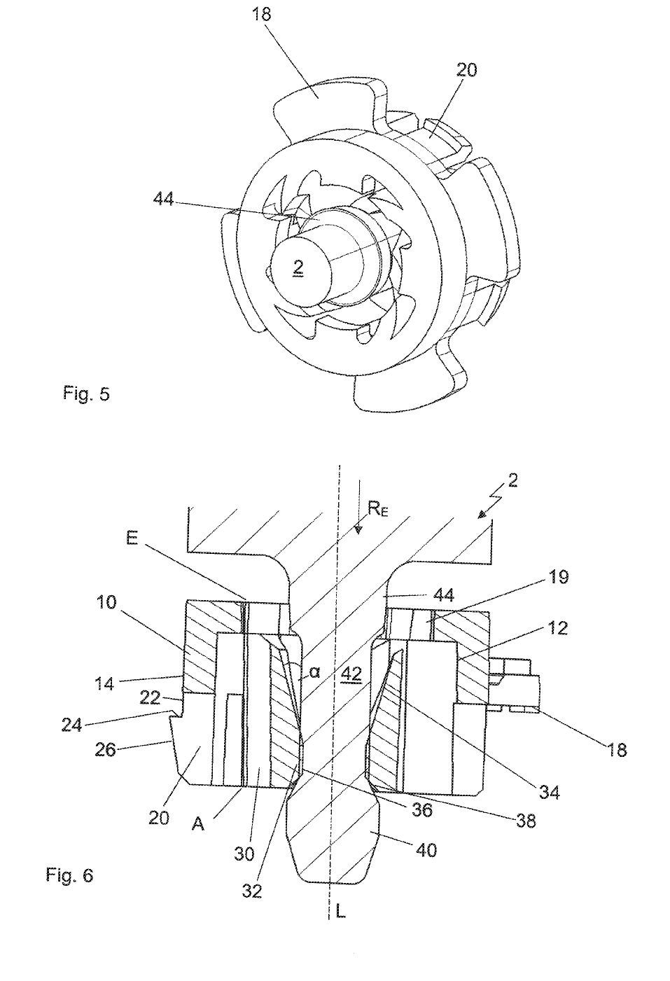

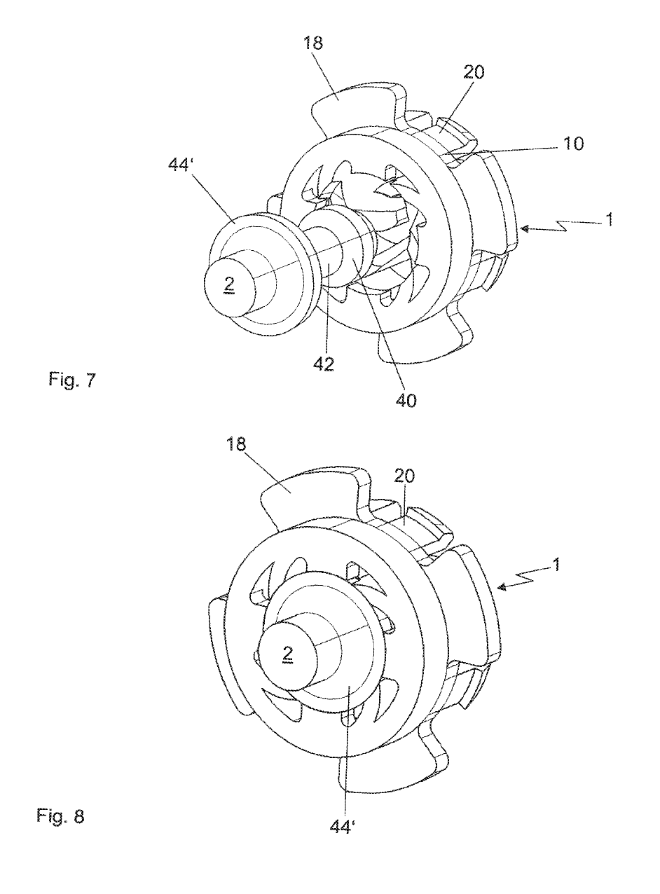

An embodiment of the annular plug-in coupling 1 is shown in a perspective view in each of FIGS. 1 and 2. In order to establish a connection between a first B1 and a second component B2, the annular plug-in coupling 1 is latched or generally fastened in a component opening O of the first component B1. In the second component B2, a coupling pin 2 is fastened. This coupling pin 2 is screwed or glued into a component opening, riveted thereto or the like.

The coupling pin 2 is plugged into the annular plug-in coupling 1 from an entry side E until the coupling pin 2 latches into it. This is shown in FIG. 4, where a bulbous head 40 of the coupling pin 2 is arranged latched at an exit side A of the plug-in coupling. Instead of the head 40 shown here, a ball head, a lens head or a similar thickening can also be used as a head in combination with a pin.

The plug-in coupling 1 has a hollow cylindrical ring structure 10, which extends parallel to an axial longitudinal axis L. The ring structure is of band-like design and has a radial inner side 12 and a radial outer side 14. According to various embodiments, the ring structure 10 is formed to run circumferentially continuous or with regular apertures 16.

The plug-in coupling 1 is fastened via the radial outer side 14 in a component opening. According to different embodiments, the radial outer side 14 of the ring structure 10 is provided with a thread and screwed into the component opening. According to another embodiment, the radial outer side 14 is glued into the component opening. According to another embodiment, the ring structure 10 is latched into the component opening O.

In order to latch the annular plug-in coupling 1 in the component opening O, radially projecting retaining surfaces 18 are provided at the radial outer side 14. A plurality of these retaining surfaces 18 are distributed evenly over the circumference of the ring structure 10. These retaining surfaces 18 form an axial undercut in an insertion direction R_{E}, so that the annular plug-in coupling 1 can only be inserted into the component opening O up to the retaining surfaces 18. For this, it is necessary that the retaining surfaces 18 extend radially beyond a diameter of the component opening.

A plurality of latching means, resilient latching hooks 20, are also arranged on the radial outer side 14. The latching hooks 20 have an axial web 22, a locking axial undercut 24 and an insertion slope 26. The undercut 24 is arranged transversely to the longitudinal axis L of the plug-in coupling 1 and thus is opposite to the retaining surface 18. Thus, the undercut 24 of the latching hook 20 forms an axial undercut contrary to the insertion direction R_{E} of the plug-in coupling 1. In order to be able to insert the plug-in coupling 1 into the component opening O, the latching hooks 20 are constructed so as to be resilient radially inwards via the axial webs 22. If the plug-in coupling 1 is thus inserted into the component opening O, the latching hooks 20 initially spring radially inwards and then lock themselves to the edge of the component opening O. Thereafter, the retaining surfaces 18 and the axial undercut 24 are arranged on opposite surfaces of the first component B1 and prevent an unintentional release of the plug-in coupling 1 out of the component opening O.

From the radial inner side 12 of the hollow cylindrical ring structure 10, a plurality of band-like spring arms 30 extend radially inwards. These spring arms 30 form the centrally arranged latching structure 28. In accordance with a further embodiment, the spring arms 30 are formed band-like so that they have a spring arm width in the longitudinal direction L and a spring arm thickness transverse thereto. The spring arm width is greater than the spring arm thickness. In this regard, it may be preferred that the spring arm width is arranged in an inclined or parallel manner with respect to the longitudinal direction L of the plug-in coupling 1 or is arranged in an inclined and/or parallel manner thereto at least in sections. This specific arrangement of the spring arms 30 supports a precise adjustment of the spring behavior of the spring arms 30 in order to reliably lock the coupling pin 2 within the plug-in coupling 1.

In addition, it may be preferred that the spring arms 30 extend straight or curvilinear radially inwards depending on the retention force to be achieved for the coupling pin 2. In the case of a rectilinear course of the spring arms 30, these may be compressed reversibly in their radial longitudinal direction in order to receive the coupling pin 2. In the case of a curved or arc-shaped course, as shown for example in FIG. 2, the spring arms 30 resiliently move radially outwards when the coupling pin 2 is plugged into the plug-in coupling 1. With an increasing length of the spring arms 30, the retention force of the spring arms 30, with which they engage the coupling pin 2, decreases. The retention force of the spring arms 30 also may be adjustable via the spring arm thickness. In this context, the retention force will increase as the spring arm thickness increases.

The spring arms 30 end radially inwards in a free fastening end 22. Due to the free fastening ends 32, these can preferably move freely when inserting the coupling pin 2. After the head 40 of the coupling pin 2 has passed the fastening ends 30, the fastening ends 32 try to return to their initial position. Thereby, they come into abutment with a shaft 42 of the coupling pin 2 and clamp said shaft between each other. This can be seen in the sectional view according to FIG. 6.

In order to facilitate the insertion of the coupling pin 2 into the plug-in coupling 1, the fastening ends 32 may comprise an insertion slope 34 (see FIG. 6). The insertion slope 34 is arranged at an angle α to the longitudinal axis L of the plug-in coupling 1. This angle α has a size in the range of 5°≤α≤45°, preferably 10°≤α≤30°.

The insertion slope 34 may merge continuously into a retaining surface 36, which in turn may be connected to an extraction slope 38. The retaining surface 36 is flat or profiled and/or is provided with a certain surface roughness. These configurations ensure a reliable hold between the fastening ends 32 and the shaft 42 of the coupling pin 2. If the shaft 42 and the engaging retaining surfaces 36 are formed complementary or at least matching to each other, the fastening ends 32 would provide not only a non-positive hold but also a positive hold on the coupling pin 2.

As can be seen from the sectional views in FIGS. 6, 9 and 10, the coupling pin 2 varies in design. According to the first configuration in FIG. 6, the coupling pin 2 comprises a cylindrical shaft portion 44, which may have about the same diameter as the head 40. The plug-in coupling 1 may feature on the axial entry side E a cylindrical receiving area 19 in which the cylindrical shaft portion 44 engages. In order to enable a certain radial tolerance compensation after a connection has been established between the plug-in coupling 1 and the coupling pin 2, the cylindrical shaft portion 44 is smaller in diameter than the inner diameter of the cylindrical receiving portion 19. While the spring arms 20 yield to a radial load of the components B1, B2, the cylindrical shaft portion 44 in the cylindrical receiving portion 19 can follow the movements of the components B1, B2. In this way, the connection according to FIG. 6 represents a floating bearing between the components B1 and B2 since certain tolerance movements are made possible.

According to another embodiment, the cylindrical shaft area 44′ is adapted in its size to the cylindrical receiving opening 19 in such a manner that the cylindrical shaft area 44′ is held in the cylindrical receiving opening 19 without the possibility of radial tolerance movements relative to the plug-in coupling 1. In this context, it may be preferred to adapt the diameter of the cylindrical shaft area 44′ to the diameter of the cylindrical receiving opening 19. Both construction alternatives prevent tolerance compensation movements in the radial direction between the first B1 and the second component B2, so that the connection between the plug-in coupling 1 and the coupling pin 2 constitutes a fixed bearing.

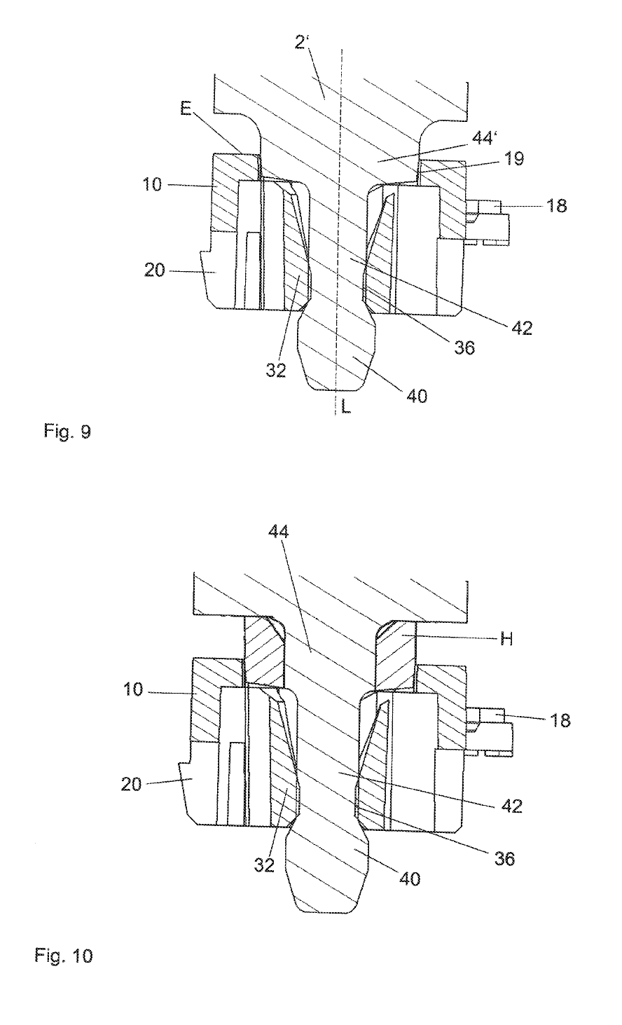

Alternatively, FIG. 10 shows another embodiment. Here, the universally applicable coupling pin 2 according to FIG. 6 is equipped with a sleeve H in order to be able to flexibly adapt the cylindrical shaft portion 44 to the cylindrical seat 19 of any size with the same coupling pin 2. Therefore, the arrangement according to FIG. 10 constitutes a fixed bearing in the same manner as the arrangement according to FIG. 9. Accordingly, the cylindrical shaft portion 44′ of FIG. 9 acts in the same manner as the sleeve H as a radial fixation for the coupling pin 2 in the plug-in coupling 1.

In order to be able to establish the above connection, the plug-in coupling 1 and the coupling pin 2 may be made of plastics with a strength between 20 and 100 MPa. These plastics may have a glass fibre reinforcement and/or other fillers. Preferred material examples are POM (polyoxymethylene), PA (polyamide), PBT (polybutylene terephthalate), PP (polypropylene), ABS (acrylonitrile butadiene styrene copolymerizate) and PTFE (polytetrafluoroethylene). According to an embodiment, the coupling and the coupling pin consist of an integral plastic part. It further may be preferred that the plug-in coupling 1 is a hybrid component in which the spring arms 30 and/or the ring structure are reinforced by metal inserts.

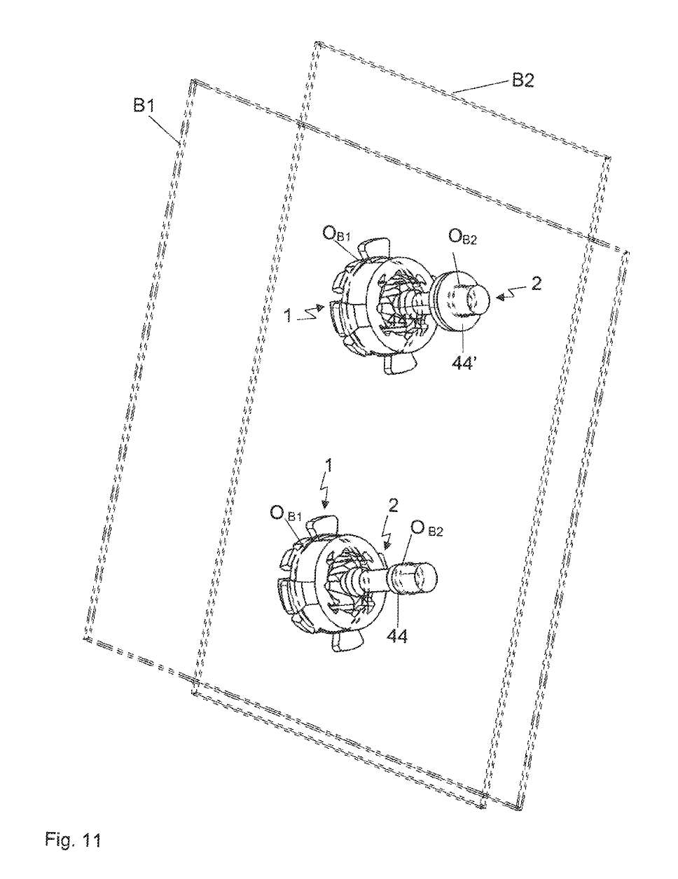

According to a further embodiment, a multi-point snap-on mounting (see FIG. 11), may be a two-point or three-point snap-on mounting, is used for a rear lamp on the outer body of a motor vehicle. This mounting can also be used analogously for any other attachment components, such as fairings, peripheral devices, equipment accessories etc. in the vehicle, generally in the automotive industry, in the construction industry and in vehicle construction. For this, one or two coupling pins 2 in combination with a plug-in coupling 1 are used as floating bearing, as shown in FIG. 6. A further combination uses the plug-in coupling 1 in connection with a coupling pin 2, as shown in FIGS. 9 to 10 and as described in this regard. A combination according to FIG. 9 or 10 serves as a fixed bearing. The fixed bearing first absorbs the transverse forces on the connection of the two components B1, B2. In addition, the fixed bearing may represent the dimensional fixed point of the arrangement in the outer vehicle body in order to ensure the precisely defined position of the two components B1 and B2 in relation to each other. In this way, gap dimensions may be maintained for attachment components on motor vehicles. The snap-on connections are established almost simultaneously. The fixed bearing ensures the positional accuracy of the attachment component, while the floating bearings realize with respect to the fixed bearing a reliable additional snap-on connection regardless of existing alignment inaccuracies or tolerances between the components B1 and B2.

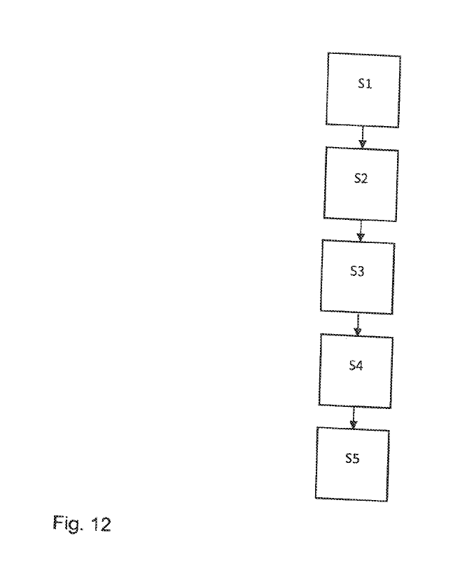

The connection method for the two components B1, B2 can be summarized as follows. In step S1 (see FIG. 12), at least a first and a second plug-in coupling 1 according to one of the embodiments described above is arranged in a respective component opening O of the first component. Then a fastening of a first and a second coupling pin takes place in the second component in an arrangement adapted to the arrangement of the first and second plug-in coupling in the first component, wherein one of the coupling pins comprises the cylindrical thickening as a radial fixation in combination with the plug-in coupling and the other coupling pin is provided without a cylindrical thickening (step S2). At step S3, the coupling pin is plugged into the first and the second plug-in coupling and is then locked (step S4). To prepare for the connecting, it may be necessary to provide the coupling pin with a cylindrical thickening as an integral coupling pin or as a coupling pin with a sleeve. In addition, it may be preferred to plug (S5) the coupling pin with thickening into the cylindrical ring structure such that the cylindrical thickening in the cylindrical seat is arranged adjacent to the entry side of the ring structure, so that the cylindrical seat prevents a radial displacement of the received cylindrical thickening.

1. An annular plug-in coupling which can be fastened in a component opening of a first component and has the following features:
a. a hollow cylindrical ring structure having a longitudinal axis and a radial inner side and a radial outer side,
b. a fastening structure arranged on the radial outer side of the ring structure, with which the ring structure can be fastened in the component opening,
c. a latching structure arranged centrally in the interior of the ring structure,
c1. with which a coupling pin of a second component can be releasably connected to the plug-in coupling, and
c2. which consist of at least three band-like spring arms which extend radially inwards in a curvilinear manner from the radial inner side of the ring structure and end respectively in a free fastening end, and the spring arm width of which is arranged in the longitudinal direction of the ring structure and is greater than a spring arm thickness, wherein the fastening ends comprise at least an insertion slope and a clamping portion.

2. Plug-in coupling according to claim 1, in which the spring arm width is arranged in an inclined or parallel manner with respect to the longitudinal direction of the plug-in coupling or is arranged in an inclined and/or parallel manner at least in sections.

3. Plug-in coupling according to claim 2, in which the cylindrical ring structure comprises an axial entry side and an axial exit side for the coupling pin to be fastened, and the spring arms are fastened to the radial inner side of the ring structure in the longitudinal direction of the ring structure at a distance from the entry side of the ring structure, so that a cylindrical seat is provided for a radial fixation of the coupling pin in the ring structure.

4. Plug-in coupling according to claim 2, the insertion slope of which encloses an angle <45° with the longitudinal axis of the plug-in coupling and which has an extraction slope which encloses a larger angle with the longitudinal axis than the insertion slope.

5. Plug-in coupling according to claim 2, the clamping portion of which comprises a retention face parallel to the longitudinal axis of the plug-in coupling.

6. Plug-in coupling according to claim 2, which is provided as an integral plastic part, the plastic of which comprises a strength in the range from 20 to 100 MPa.

7. Plug-in coupling according to claim 2, the ring structure of which has a first and a second undercut acting against one another in the longitudinal direction of the ring structure, of which at least the first undercut can be moved resiliently in the radial direction in order to latch the ring structure in the component opening.

8. A connection between a first component and a second component, in which the first component comprises a component opening, in which a plug-in coupling according to claim 1 is fastened, and in which a coupling pin, which is retained in the plug-in coupling of the first component, is fastened to the second component.

9. Connection according to claim 8, in which the coupling pin has an elongated shaft and a bulbous head.

10. Connection according to claim 9, in which the coupling pin has a cylindrical thickening in a shaft portion facing away from the head, which is adapted to the cylindrical seat and can be received therein.

11. Connection according to claim 10 in which the cylindrical thickening is formed integrally with the coupling pin or as a sleeve which can be fastened to the coupling pin.

12. A connection between a first and a second component, in which the first component has at least two plug-in couplings according to claim 1 each arranged in a component opening and the second component comprises two coupling pins fitting thereto, wherein one coupling pin comprises a cylindrical thickening in the shaft portion facing away from the head which is received in a cylindrical seat of the plug-in coupling in order to establish a radially fixed connection between the first and the second component.

13. Connection according to claim 12, in which the second coupling pin does not comprise a cylindrical thickening in order to ensure a radial tolerance compensation between the second coupling and the second coupling pin.

14. Connection method for a first and a second component, comprising the following steps:
a. arranging at least a first and a second plug-in coupling according to claim 1 in a respective component opening of the first component.
b. fastening a first and a second coupling pin in the second component in an arrangement adapted to the arrangement of the first and the second plug-in coupling in the first component, wherein one of the coupling pins comprises a cylindrical thickening as a radial fixation in combination with the plug-in coupling and the other coupling pin is provided without a cylindrical thickening, and
c. inserting and locking the coupling pins in the first and the second plug-in coupling.

15. Connection method according to claim 14, with the further step:
providing the coupling pin with cylindrical thickening as an integral coupling pin or as coupling pin with a sleeve.

16. Connection method according to claim 14 with the further step:
inserting the coupling pin with thickening into the cylindrical ring structure such that the cylindrical thickening is arranged in the cylindrical seat adjacent to the entry side of the ring structure such that the cylindrical seat prevents a radial displacement of the received cylindrical thickening.

17. Connection method according to claim 15 with the further step:
inserting the coupling pin with thickening into the cylindrical ring structure such that the cylindrical thickening is arranged in the cylindrical seat adjacent to the entry side of the ring structure such that the cylindrical seat prevents a radial displacement of the received cylindrical thickening.

18. Plug-in coupling according to claim 3, the insertion slope of which encloses an angle <45° with the longitudinal axis of the plug-in coupling and which has an extraction slope which encloses a larger angle with the longitudinal axis than the insertion slope.

19. Plug-in coupling according to claim 3, the clamping portion of which comprises a retention face parallel to the longitudinal axis of the plug-in coupling.

20. Plug-in coupling according to claim 3, which is provided as an integral plastic part, the plastic of which comprises a strength in the range from 20 to 100 MPa.
